(19) United States
(12) Patent Application Publication
(10) Pub. No.: US 2002/0066189 A1
(43) Pub. Date: Jun. 6, 2002

(54) Method and apparatus for securing a tang to a formed handle

(76) Inventors: Bradford Parrish, Oregon City, OR (US); Roy Jensen, Yamhill, OR (US); Jeffrey L. Jennings, Oregon City, OR (US)

Correspondence Address: Jeffrey S. Gundersen, FOLEY & LARDNER, Firstar Center, 777 East Wisconsin Avenue, Milwaukee, WI, 53202-5367, US

(21) Appl. No.: 09/731,111

(22) Filed: Dec. 6, 2000

(51) Int. Cl. B26B 3/00

(52) U.S. Cl. 30/340; 30/343

(57) ABSTRACT

An implement having a handle, a tang, and a working portion is assembled by snapping the tang into the handle. The tang has prongs that snap into a locking structure within the handle. No attachment hardware such as rivets or adhesives are necessary to secure the tang to the handle. A method of securing the tang to the handle includes snapping the tang into the handle with no further installation steps required. In a preferred embodiment, the implement is a fixed blade knife having a blade with a tang and a sharpened end.

### FIELD OF THE INVENTION

The present invention relates to an apparatus for securing a tang to a handle. More particularly, the present invention relates to a method and apparatus for securing the tang of a fixed blade knife to the handle.

### BACKGROUND OF THE INVENTION

Fixed blade knives generally are constructed of a blade attached to a handle. The blade has a tang portion that is inserted into the handle and must be attached to the handle. Common methods of attaching the tang to the handle include the use of rivets through the handle and tang and the use of an adhesive injected into the interior of the handle.

After the tang has been attached to the handle during the manufacturing process, the blade may then be sharpened; and the finished knife can be packaged and shipped. Preferably, one would like to reduce the total manufacturing time between insertion of the tang into the handle and the shipping of the final product.

When a tang is riveted to a handle, attachment holes must be put into both the handle and the tang. After the tang is inserted, the holes are lined up, and rivets are used to attach the two pieces.

When an adhesive is used to attach a tang and a handle, the adhesive is injected into the handle prior to insertion of the tang. The tang is then inserted. The blade and handle are then held in place with a pressure means, such as a clamp, or manually held, until the adhesive has set. This can take anywhere from minutes to hours depending upon the adhesive used.

Both the rivet method and the adhesive method require further steps after insertion of the tang into the handle. These further steps include either inserting and attaching rivets, or clamping the piece and waiting for the adhesive to set.

The rivet and adhesive attachment methods also require the use of additional materials. The rivet attachment method requires rivets. The adhesive attachment method requires an adhesive plus a clamping device to secure the handle and tang in place while the adhesive sets.

Therefore, it would be advantageous to have a fixed blade knife that does not require further mechanical steps after insertion of the tang into the handle. Further, it would be advantageous to have a fixed blade knife that does not require additional attachment hardware such as rivets or clamping devices. Further still, it would be advantageous to have a fixed knife that may be sharpened, packaged, and shipped immediately after insertion of the tang into the handle.

### SUMMARY OF THE INVENTION

One embodiment of the invention relates to an implement having a handle and a tang. The tang has a plurality of prongs disposed in the handle. A working portion is attached to the tang that extends away from the handle, wherein the plurality of prongs mechanically secure the tang to the handle.

A further embodiment of the invention relates to a fixed blade knife having a handle with an interior. The fixed blade knife has a blade having a working portion and a tang. A plurality of prongs extend from the tang. A locking structure within the interior is configured to retain the tang when the blade is coupled to the handle.

A still further embodiment of the invention relates to a method of assembling a fixed blade knife. The method includes the steps of providing a handle, providing a blade having a tang with a plurality of prongs, and inserting the tang into the handle until the prongs snap into place. The tang is thereby locked into position.

### BRIEF DESCRIPTION OF THE DRAWINGS

An exemplary embodiment will hereafter be described with reference to the accompanying drawings, wherein like reference numerals denote like elements, and:

FIG. 1 is a perspective view of a fixed blade knife before installation of the blade into the handle;

FIG. 2 is a plan view of the blade of the fixed blade knife;

FIG. 3 is a partial plan view showing an end of a prong of the tang;

FIG. 4 is a sectional view of the handle of a fixed blade knife.

### DETAILED DESCRIPTION OF THE PREFERRED EMBODIMENTS

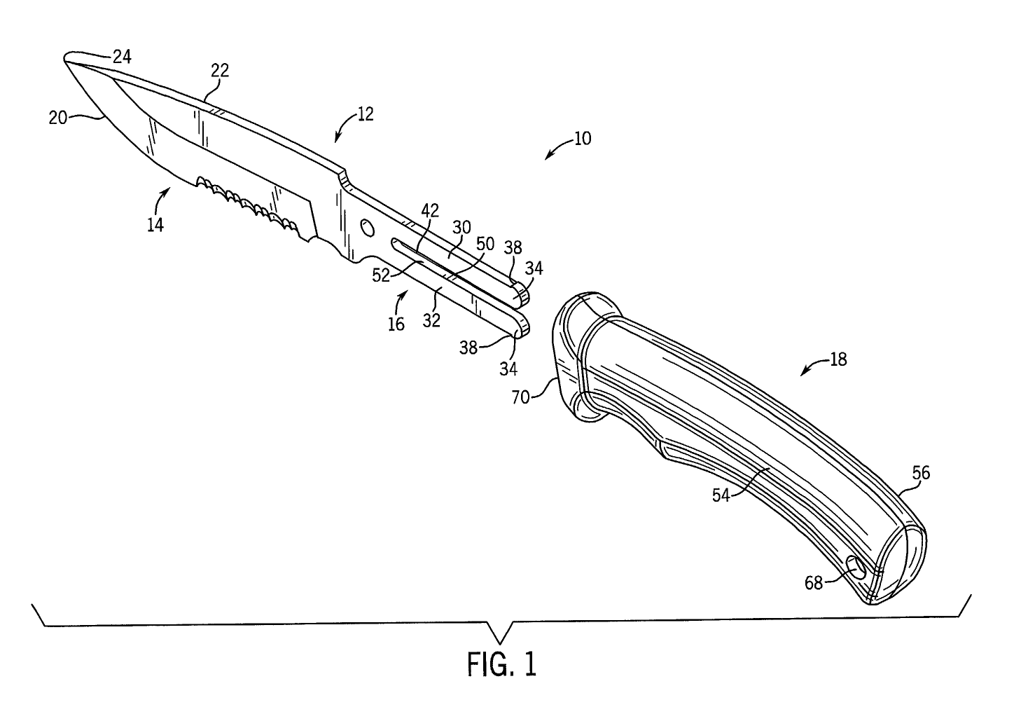

FIG. 1 shows an implement constructed in accordance with a first embodiment of the present invention. The implement, shown as a fixed blade knife 10, has a blade 12 and a handle 18. The blade 12 has a working portion 14 and a tang 16. The working portion 14 has a sharpened edge 20, a back edge 22, and a point 24. The tang 16 of the blade 12 has two prongs, a first prong 30 and a second prong 32. The first prong 30 has an end 34 with an associated notch 38. The second prong 32 has an end 36 with an associated notch 40. A slot 42 runs between the two prongs 30 and 32.

In an alternative embodiment, the implement could be any device having a working portion, a tang, and a handle. Implements such as gardening tools, barbecue tools, and surgical instruments all have structures that are encompassed by the present invention.

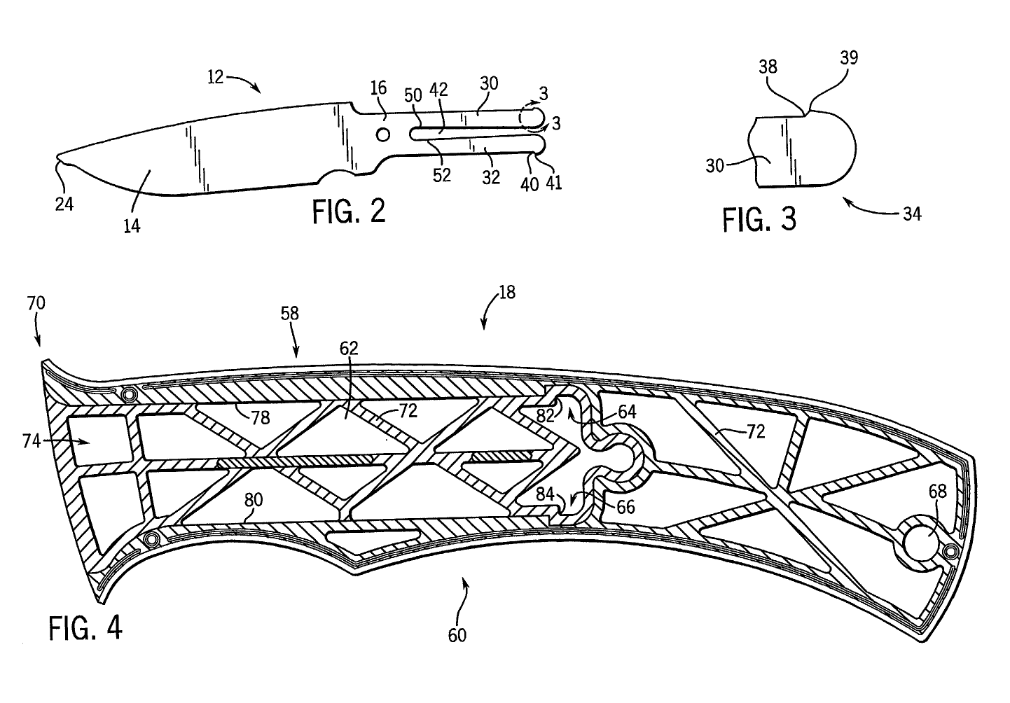

Referring to FIG. 2, in a preferred embodiment, the blade 12 is of single piece construction and made of steel. The working portion 14 is about four inches long. The blade 12 is about seven inches in total length, including the tang 16. The slot 42 extends about two inches to ends of prongs 30 and 32. Each prong 30 and 32 is tapered toward the other along interior edges 50 and 52 at an angle of about 1.3 degrees.

In alternative embodiments, the working portion 14 and the tang 16 could be mechanically attached to form the blade 12. Additionally, the dimensions of the blade 12 recited above could vary according to the desired uses of the implement.

Referring back to FIG. 1, in a preferred embodiment, the handle 18 has a left side 54 and a right side 56. The handle 18 also has a palm side 58 and a finger side 60 (see FIG. 4). The handle 18 is of two piece construction comprising the left side 54 and the right side 56. The handle may be molded, cast, or machined. Handle materials can include plastic, resin, wood, metal, or any material suited to the chosen manufacturing method. A hole 68 may be molded into the handle 18 suitable for a lanyard. The left side 54 and the right side 56 of the handle 18 are attached prior to insertion of the tang 16, preferably using an ultrasonic attachment means.

In alternative embodiments, the handle 18 need not be injection molded. The handle 18 can be made of a variety of materials including materials such as steel or wood. Nor is the two-piece construction of the handle 18 necessary. The handle 18 may be molded as a single piece, or assembled from a multitude of pieces.

Referring now to FIG. 3, the end 34 of prong 30 is shown. The notch 38 is cut into the end 34 to form a point 39. Referring to FIG. 2, prong 32 has a similar structure at the end 36. The notch 40 is formed on end 36 creating a point 41.

Referring to FIG. 4, each side of the handle 18 has a formed interior 62. The interior 62 has an upper wall 78 and a lower wall 80 that define an insertion slot 74. The interior 62 has a locking structure 64 for the first prong 30 and a locking structure 66 for the second prong 32. The locking structure 64 has a catch 82 and the locking structure 66 has a catch 84. The catches 82 and 84 coact with notches 38 and 40 to lock the tang 16 in place. The interior 62 of the handle 18 has a molded structure designed to provide rigidity. Ribs 72 throughout interior 62 provide the desired structure.

In alternative embodiments, the slot 74 may be of any size that allows the tang 16 to be inserted into the handle 18. Additionally, the locking structures 64 and 66 may take any of a variety of configurations that will lock the ends 34 and 36 of the prongs 30 and 32 into place.

In an exemplary embodiment, the handle 18 has the following dimensions. The distance from the aperture 68 to a front 70 of the handle 18 is about 4.3 inches. The approximate width from the finger side 60 to the palm side 58 is about 0.9 inches. The ribs 72 are typically about 0.05 inches thick. The locking structures 64 and 66 are sized to fit the notches 38 and 40 of the prongs 30 and 32.

The prongs 30 and 32 function as springs to lock the tang 16 into the handle 18. The insertion slot 74 of the handle 18 has a width in an exemplary embodiment of about 0.6 inches. This is more narrow than the distance between the point 39 of the notch 38 and the point 41 of the second notch 40. Thus, the prong 30 and the prong 32 are compressed toward one another as the tang 16 slides into the handle 12 during assembly of the fixed blade knife 10. Upon complete insertion, the ends 34 and 36 of the respective prongs 30 and 32 snap outward into the locking structures 64 and 66. Once snapped into place, the blade 12 may not be removed from the handle 18 because the notches 38 and 40 retain the prongs 30 and 32 in place by catching on the locking structures 64 and 66.

Thus, each prong 30 and 32 is essentially a steel spring designed to deflect inward during assembly of the fixed blade knife 10, and, when in final position, spring outward to retain the tang 16 in the handle 18.

Once the blade 12 has been inserted into the handle 18, the fixed blade knife 10 is ready for use. At that point, the fixed blade knife 10 may be sharpened, packaged, and shipped for retail delivery. Steps such as riveting the tang 16 into the handle 18 or the use of an adhesive to bond the tang 16 to the handle 18 are not required because the prongs 30 and 32 adequately retain the tang 16 in the handle 18.

In an alternative embodiment, a filler, such as a castable resin, can be inserted into the handle 18 prior to insertion of the tang 16. The resin further strengthens the bond between the tang 16 and the handle 18. The resin will also prevent moisture from entering the cavity 76 of the handle 18. Because of the prong design however, there is no requirement to wait for the resin to set prior to packaging the fixed blade knife 10 for shipment, unless desired by the manufacturer. No delay is required because the tang 16 is physically locked in the handle 18 by the prongs 30 and 32.

The castable resin, such as epoxy, serves as a mechanical “block” between the prongs 30, 32. Once set, the block prevents the prongs 30, 32 from compressing, which prevents release of the mechanical lock between the handle 18 and the tang 16. The mechanical block function of the castable resin can be contrasted with the conventional use of an adhesive, where the design relies on adhesion between the handle 18 and tang 16.

Alternatives to the use of the prongs 30 and 32 with the notches 38 and 40 include other mechanical attachment means for locking the tang 16 into the handle 18 without the further manufacturing steps of the prior art, such as adding rivets or adhesives. For example, the slot 42 could be omitted, requiring the notches 38 and 40 to deform the insertion slot 74 of the handle 18 as the tang 16 is inserted, until the handle 18 snaps back into position, once the ends 34 and 36 of the tang 16 are fully inserted. This results in the same locked configuration as when the prongs 30 and 32 deform inward when the tang 16 is inserted into the handle 18. Another alternative embodiment is a recessed catch at the end of the tang 16 that would snap outward when the tang 16 has been fully inserted into the handle 18.

Alternatives to the locking structures 64 and 66 include any structure that prevents the tang 16 from being withdrawn from the handle 18 once the tang 16 has been inserted. Structures such as a stepped edge of the insertion slot 74 could prevent the tang 16 from being withdrawn, while allowing the tang 16 to be inserted into the handle 18.

The implement described herein does not require attachment hardware, such as rivets, or additional materials such as a clamping device or adhesives, to assemble the tang and handle into fixed relationship with one another. Additionally, the present invention allows a simpler method of assembly of a tang and handle because no further steps are necessary after insertion of the tang into the handle. It is an advantage of the invention that additional steps, such as riveting the tang and handle together, or waiting for an adhesive to set are not required.

While several embodiments of the invention have been described, it should be apparent to those skilled in the art that what has been described is considered at present to be the preferred embodiments of an implement and a method of manufacture of the implement. However, changes can be made in the design without departing from the true spirit and scope of the invention. The following claims are intended to cover all such changes and modifications which fall within the true spirit and scope of the invention.

What is claimed is:

1. An implement, comprising:
a handle;
a tang having a plurality of prongs disposed in the handle; and
a working portion attached to the tang, extending away from the handle, wherein the plurality of prongs mechanically secure the tang to the handle.

2. The implement of claim 1, wherein the working portion comprises a blade.

3. The implement of claim 1, wherein the working portion comprises a fixed blade knife.

4. The implement of claim 1, wherein the working portion comprises a kitchen utensil.

5. The implement of claim 1, wherein the working portion comprises a gardening tool.

6. The implement of claim 1, wherein the implement comprises a hand tool.

7. The implement of claim 1, wherein the tang includes two prongs.

8. The implement of claim 1, wherein the tang includes four prongs.

9. The implement of claim 1, further comprising:
a locking structure within the handle; and
a flared end located on each prong wherein the locking structure coacts with the flared ends to retain the tang in a fixed embedded structure.

10. The implement of claim 1, wherein the tang snaps in to the handle.

11. The implement of claim 1, further comprising: a filler disposed in the handle.

12. The implement of claim 1, wherein no rivets are used to secure the tang to the handle.

13. The implement of claim 1, wherein no adhesive is used to secure the tang to the handle.

14. A fixed blade knife, comprising:
a handle having an interior;
a blade having a working portion and a tang;
a plurality of prongs extending from the tang; and
a locking structure within the interior configured to retain the tang when the blade is coupled to the handle.

15. The fixed blade knife of claim 14, wherein two prongs extend from the tang.

16. The fixed blade knife of claim 14, wherein four prongs extend from the tang.

17. The fixed blade knife of claim 14, further comprising: a flared end located on each prong wherein the locking structure coacts with the flared ends to retain the tang.

18. The fixed blade knife of claim 14, wherein the tang snaps into the handle.

19. The fixed blade knife of claim 1 4, further comprising:
a filler disposed in the interior.

20. The fixed blade knife of claim 14, wherein no rivets are used to secure the tang to the handle.

21. The fixed blade knife of claim 14, wherein no adhesive is used to secure the tang to the handle.

22. A method of assembling a fixed blade knife, comprising the steps of:
providing a handle,
providing a blade having a tang with a plurality of prongs; and
inserting the tang into the handle until the prongs snap into place, whereby the tang is locked into position.

23. The method of claim 22, further comprising the step of:
injecting a filler into the handle.

24. The method of claim 22, wherein the filler comprises a castable resin.

25. The method of claim 22, wherein the prongs deflect toward one another as the tang is inserted into the handle and the prongs spring into locked position after the tang is inserted into the handle.
